(19) United States
(12) Patent Application Publication
(10) Pub. No.: US 2018/0200152 A1
(43) Pub. Date: Jul. 19, 2018

(54) Adult Necklace and Infant Teething Devices

(71) Applicant: Lullie & Me, LLC, Dallas, TX (US)

(72) Inventor: Laura Price, Dallas, TX (US)

(21) Appl. No.: 15/408,394

(22) Filed: Jan. 17, 2017

(51) Int. Cl. A61J 17/02; B29C 65/56; B29C 65/00

(52) U.S. Cl. CPC A61J 17/02; B29C 65/565; B29K 2083/00; B29C 66/12421; B29C 65/562

(57) ABSTRACT

Adult necklace and infant teething devices are disclosed that among other things have the appearance of small pieces that if they were as appeared might pose a choking hazard if disassembled but are actually made of larger pieces—modular units—that do not pose a choking hazard if separated from the necklace. In this way, the wearer may look fashionable but also have a safe teething device ready for an infant to use while being held by the wearer. Other aspects are disclosed.

### TECHNICAL FIELD

The present invention relates to jewelry and more particularly to adult necklace and infant teething devices.

### BACKGROUND

When infants reach a certain developmental stage, they begin to teethe. In this stage, teeth begin to work their way through the infant's gums causing pain or discomfort. As used herein, unless clear from the context, “or” does not require mutual exclusivity. In response to the movement of the teeth, infants often place things into their mouth to chew on them. Doing so posses a risk in that a toxic, sharp, or small item may be obtained by an infant and placed in his or her mouth. To avoid this, parents often use teething rings, but they are often lost or dropped or are not convenient.

### SUMMARY

According to an illustrative embodiment, a necklace and teething device includes a plurality of modular units coupled to one another to form a ring to be placed around a wearer's neck and having an interior diameter in a range between about 15 inches and 40 inches, wherein each modular unit of the plurality of modular units comprises a non-toxic substance suitable for an infant to place in his or her mouth. Each modular unit of the plurality of modular units is sized to not be a choking hazard if separated and namely do not fit in a cylinder having an interior radius of 1.25 inches and a longitudinal length of 2.25 inches. Each modular unit comprises a plurality of faux decorative members that form a single modular unit but at least some of the faux decorative members appear to be individual decorative pieces of a size that would fit in a cylinder having an interior radius of 1.25 inches and a longitudinal length of 2.25 inches. The adult necklace and teething device includes an attachment connector consisting of one from a group: an attachment cord, wherein each of the plurality of modular units is formed with a bore through each modular unit, and wherein the attachment cord is disposed through the bores of each of the modular units to hold the plurality of modular units in the ring, and a plurality of coupling devices for coupling adjacent ends of modular units of the plurality of modular units to form the ring.

In another illustrative embodiment, a necklace and teething device is a combination necklace for an adult to wear and a teething item for an infant is presented. The necklace and teething device is made with a plurality of modular units coupled together that make a ring that goes around the wearer's neck. The necklace and teething device appears to an observer two to three feet away to include small decorative elements or units that if they were separated from the necklace would pose a choking hazard, but in fact, the decorative elements or units are formed as a single, integral piece as part of the modular unit in order to be of a size not to pose a choking hazard. The decorative elements are on an exterior of the modular units. The modular units are made from a non-toxic material suitable for an infant to chew on. The modular units may be coupled by using a string or cord that runs through bores through the center of each modular unit. The modular units may also be coupled using coupling devices between adjacent ends of the modular units. The units are made from a non-toxic plastic material of the type from which conventional teething rings are made. The decorative elements may take any of numerous forms such a combination of geometric shaped beads. The wearer may wear the necklace and teething device and an infant may chew on the modular units as a teething device.

In one illustrative embodiment, an adult necklace and infant teething device is presented that among other things has the appearance of small pieces that if they were as appeared might pose a choking hazard if disassembled but are actually made of larger pieces—modular units—that do not pose a choking hazard if separated from the necklace. In this way, the wearer may look fashionable but also have a safe teething device ready for an infant to use while being held by the wearer. Other aspects are disclosed.

### DESCRIPTION OF THE DRAWINGS

Illustrative embodiments of the present invention are described in detail below with reference to the attached drawing figures, which are incorporated by reference herein and wherein:

FIG. 1 is a schematic plan view of an illustrative embodiment of an adult necklace and infant teething device;

FIG. 2 is a side elevation view of the adult necklace and infant teething device of FIG. 1;

FIG. 3 is a plan view of the adult necklace and infant teething device of FIG. 1 shown as a slightly exploded view;

FIG. 4 is a schematic plan view of another illustrative embodiment of an adult necklace and teething device;

FIG. 5 is a schematic perspective view of a coupling device;

FIG. 6 is a schematic diagram of a clasp for use as an aspect of an adult necklace and infant teething device;

FIG. 7 is a schematic plan view of another illustrative embodiment of an adult necklace and infant teething device;

FIG. 8 is a schematic plan view of another illustrative embodiment of an adult necklace and infant teething device;

FIG. 9 is a schematic plan view of another illustrative embodiment of an adult necklace and infant teething device; and

FIG. 10 is a schematic plan view of another illustrative embodiment of an adult necklace and infant teething device.

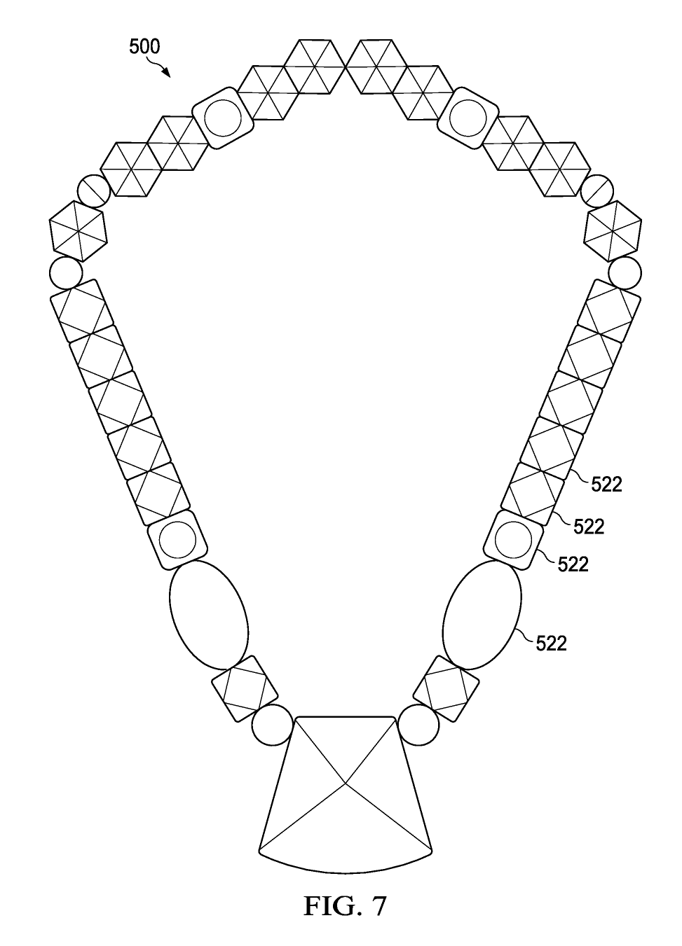

FIGS. 7A, 8A, and 9A are photographs on which FIGS. 7, 8, and 9, respectively, are based.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

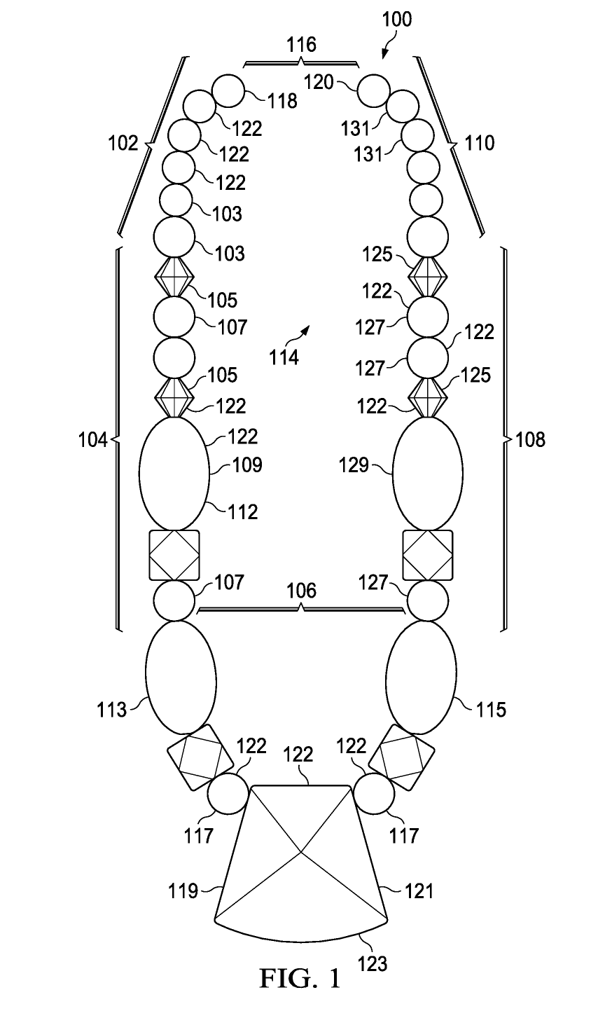

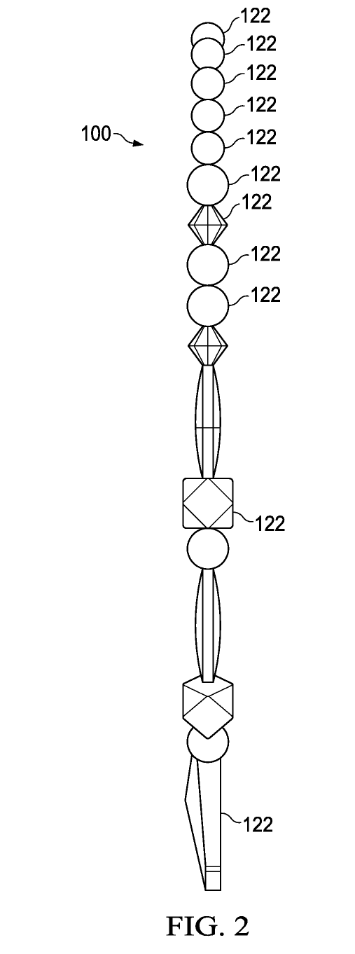

Referring now to the drawings, and initially primarily to FIGS. 1-3, one illustrative embodiment, a necklace and teething device 100 includes a plurality of modular units 102, 104, 106, 108, and 110 that are coupled one to another by an attachment connector 111 to form a ring 112 that is placed around a wearer's neck (not shown but would go where reference numeral 114 is directed). The ring 112 is shown in FIG. 1 with an opening 116 for illustration purposes but in use would be a closed ring. In some embodiments a clasp (e.g., 440 in FIG. 6) may be attached at the closure ends 118 and 120 of the ring 112. The ring 112 has an interior diameter suitable for use on most women's necks, e.g. 15″-40″.

The plurality of modular units 102-110 is made from non-toxic substances that are suitable to be placed in an infant's mouth such as materials used for conventional teething rings. The substances used to from the modular units may be, for example, without limitation, the silicone, plastic, styrene, synthetic rubber or natural rubber, styrene-acrylonitrile resin, or the like or any material used for teething rings.

Each modular unit of the plurality of modular units 102-110 is sized to not be a choking hazard if separated from the others modular units. In other words, if the attachment connector 111 that is used to hold the modular units in the ring breaks, the individual resultant pieces (modular units 102-110) would not pose a choking hazard. In one instance, this means that none of the constituent parts (modular units 102-110) is small enough to fit into a test cylinder having the following dimensions: 2.25 inches (57.10 mm) in longitudinal length and 1.25 inches (31.70 mm) in interior radius. Each modular unit 102-110 is made with a plurality of faux decorative members 122 on an exterior. Thus while the modular unit 102-110 is a single modular unit that is of the desired size, the appearance from two to three feet away is that the individual decorative pieces (the faux decorative members 122) make up the necklace. The decorative pieces or faux decorative members 122 appear to be of a size that would fit or many of them would fit into the test cylinder of the size previously described, but in actual fact, of course, they would not because they form a larger unit in the form of a modular unit 102-110. This allows for enhanced aesthetics while providing safety vis-à-vis choking.

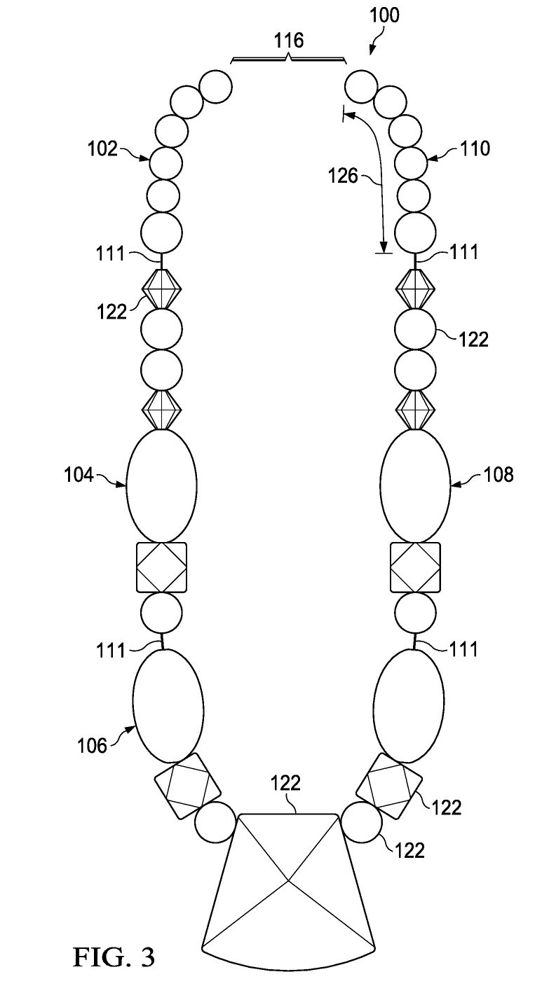

It should be noted that in FIG. 3, the modular units 102, 104, 106, 108, and 110 have been spaced from each other to show the attachment connector 111 in the form of a cord or wire 124. In addition, the ring 112 is shown again with an opening 116 that would be closed either by a clasp or by making the attachment connector 111 a continuous loop. In this view, one may see that the smallest of the modular units, modular unit 110, has a longitudinal length 126 that is too long to fit in the test cylinder that is 2.25 inches (57.10 mm) in longitudinal length and 1.25 inches (31.70 mm) in interior radius. In another embodiment, the longitudinal length 126 may be less than 2.25 inches, but the radius of the modular unit 110 may be greater than 1.25 inches so to still avoid being a choking hazard.

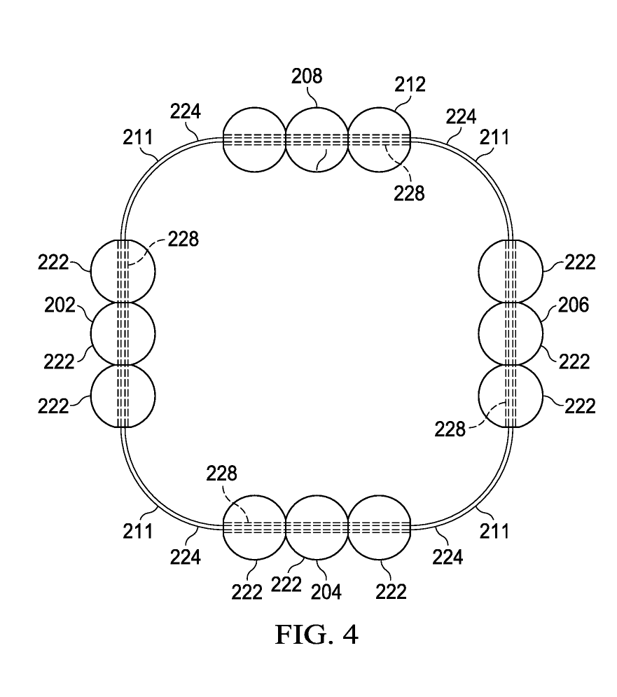

Referring to FIG. 4, a schematic representation of another illustrative embodiment of a necklace and teething device 200 is presented. The necklace and teething device 200 is analogous in most respects to the necklace and teething device 100 of FIGS. 1-3, and accordingly, some parts may be labeled but not further described here. In addition, components referenced but not explicitly shown are analogous to those previously presented, and indexing the numbers by one hundred indicates analogous parts. Thus, the necklace and teething device 200 has a ring made with a plurality of modular units 202, 204, 206, and 208 coupled using an attachment connector 211. The attachment connector 211 in this illustrative embodiment is formed as an attachment cord 224, and wherein each of the plurality of modular units 202, 204, 206, and 208 is formed with a bore 228 through each modular unit 202-208, and wherein the attachment cord 224 is disposed through the bores 228 of each of the modular units 202-208 to hold the plurality of modular units in the ring 212. It should be noted that the modular units need not fill the cord 224 fully in each embodiment; in other words, there may be a gap where the cord 224 is visible and forms a portion on the ring itself. FIG. 0.4 may be viewed as such a situation.

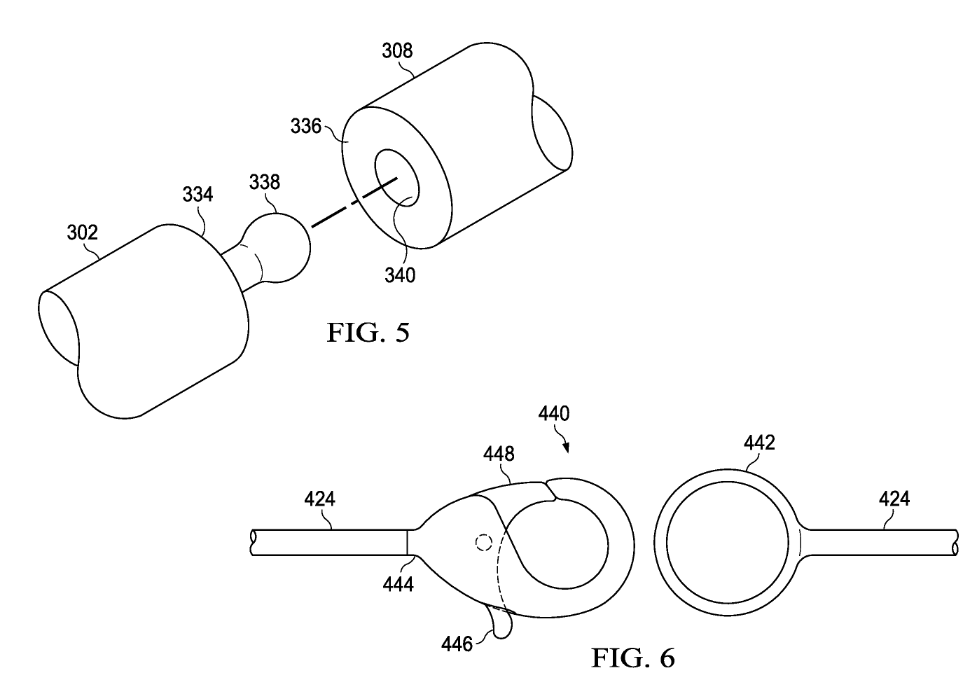

Referring to FIGS. 4 and 5, in some illustrative embodiments, the plurality of modular units 202-208 may be coupled with an attachment connector that comprises a plurality of coupling devices, e.g., coupling device 332, for coupling adjacent ends, e.g., ends 334 and 336, of modular units, e.g., modular units 302 and 308, of the plurality of modular units to form the ring. This may take many forms, but one illustrative form is shown in FIG. 5 in which the coupling device 332 includes a male member 338 and a female member 340 wherein introduction of the male member 338 into the female member 340 requires at least temporary compression of a portion of the male member 338 or expansion of the female member. Once inserted, the coupling device 332 will hold the two ends 334 and 336 in relative position with certain force loads.

Referring now to FIG. 6, a releasable clasp 440 may be used to secure two sends of the cord 424 (see also 124, 224) to allow the ring 112, 212 to be selectable opened and closed. The releasable clasp 440 may take numerous forms, but is shown in FIG. 6 as a combination of a set loop member 442 and an openable loop 444. The user may depress lever 446 of the openable loop 444 to open a portion 448 of that loop to allow the loops to be connected to form a solid ring and again the lever 446 may be depressed to open the portion 448 to allow the loops to be disconnected. In other embodiments, the releasable clasp 440 may comprises a barrel flat clasp, a spring ring clasp, a lobster claw clasp, a magnetic bali clasp, a toggle clasp, an oval toggle, alligator clip, or loop-and-hook closure.

Again, the attachment connector maybe used to hold the plurality of modular units 102-110, 202-208 in the ring 112, 212. The attachment connector may be any of a number of approaches for establishing the ring. For example, in one embodiment, the attachment connector is an attachment cord that runs through channels or bores formed through the modular units. The cord is attached at its ends to form a complete 360. In another embodiment, the cord may end with a releasable clasp on the end that allows the wearer to disconnect the ring and to make it easy to put on and take off. The releasable clasp may also be designed to rupture when too much force is put on it. Another example of an attachment connector is to use a plurality of coupling devices to couple adjacent ends of the modular units to form the ring. The coupling devices may be, for example, without limitation, a male end and a female end that form a releasable connection when male member is inserted into the female member. This insertion requires some deflection of the male member as it goes in and then it expands to form the coupled device.

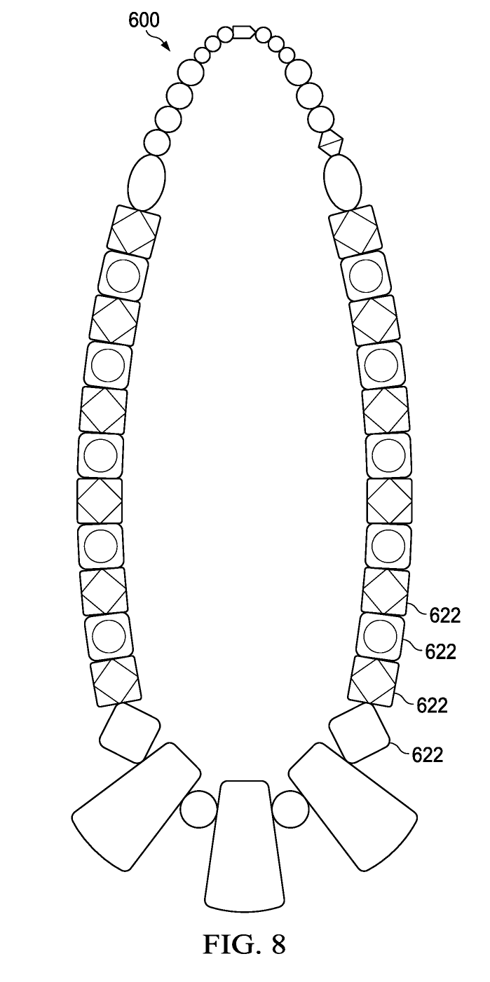

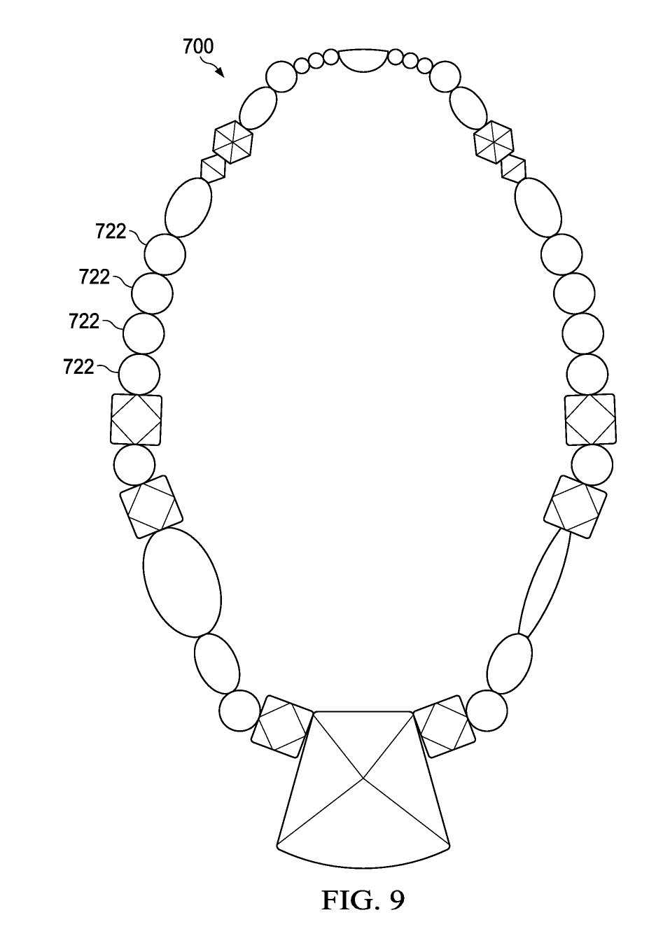

The adult necklace and teething devices may take many different embodiments with different numbers of modular units and with various numbers and styles of faux decorative members. As an additional example, without limitation, FIG. 7 shows another illustrative adult necklace and teething device 500 having a plurality of modular units and a plurality of faux decorative members formed thereon. As still another example, without limitation, FIG. 8 shows another illustrative adult necklace and teething device 600 having a plurality of modular units and a plurality of faux decorative members formed thereon. As yet another example, without limitation, FIG. 9 shows another illustrative adult necklace and teething device 700 having a plurality of modular units and a plurality of faux decorative members formed thereon.

The faux decorative members 122, 222, 322, 422, 522, 622, and 722 may take any of numerous shapes and sizes—some of which are shown in the figures. It should be understood that many other shapes and sizes may be used. In one embodiment, one or more of the faux decorative members may be formed to look like individual decorative beads. In another illustrative embodiment, the faux decorative members may be formed to look like a sphere, ellipsoid, cylinder, prism, parallelepiped, pyramid, polyhedron, or other geometric shape. The faux decorative embers may be formed directly when the modular units are being formed or may be etched into the modular units or applied by other like techniques.

Referring again to FIG. 1, in one illustrative, non-limiting example, the plurality of modular units 102-110 includes the first modular unit 102, second modular unit 104, third modular unit 106, fourth modular unit 108, and fifth modular unit 110. The first modular unit 102 includes a singular member having a first plurality of faux decorative members 122 that includes a first plurality of spheres. The second modular unit 104 includes a singular member having a second plurality of faux decorative members 122 that include a first plurality of polyhedrons 105, a second plurality of spheres 107, and at least a first ellipsoid 109. The third modular unit 106 includes a singular member having a third plurality of faux decorative members 122 including at least a second and third ellipsoid 113, 115, a third plurality of spheres 117, and a member 119 having a two dimensional silhouette that has three straight edges 121 and one curved edge 123. The fourth modular unit 108 includes a singular member having a fourth plurality of faux decorative members 122 comprising a second plurality of polyhedrons 125, a fourth plurality of spheres 127, and at least a fourth ellipsoid 129. Finally, the fifth modular unit 110 includes a singular member having a fifth plurality of faux decorative members 122 comprising a fifth plurality of spheres 131.

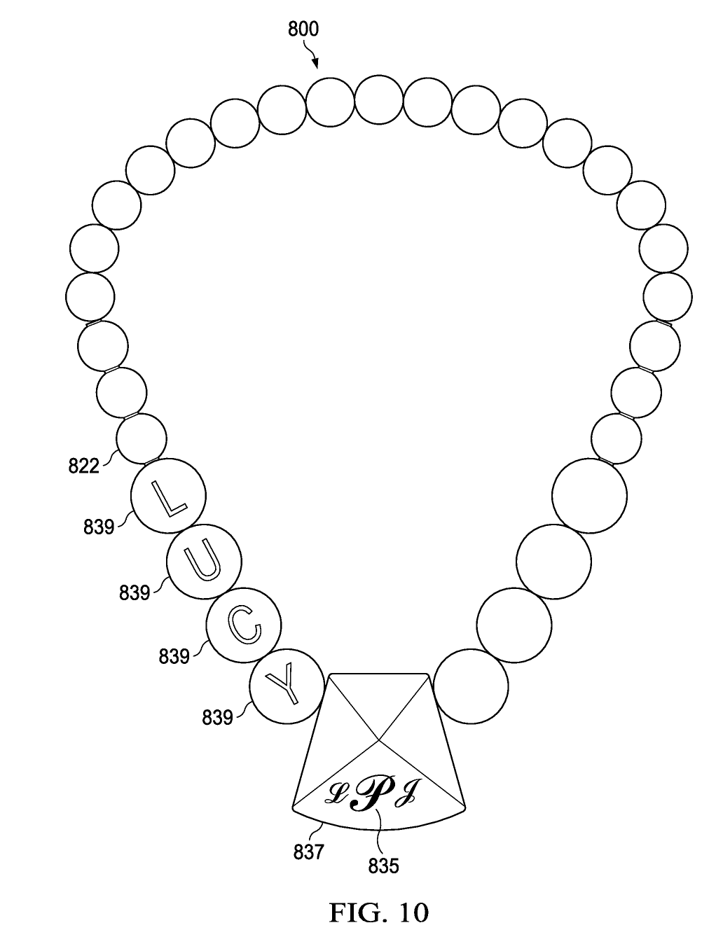

Referring now to FIG. 10, another illustrative embodiment of an adult necklace and infant teething device 800 is presented. The adult necklace and infant teething device 800 is analogous to others with a modular unit 802 having a plurality of faux decorative members 822. In this embodiment, one or more of the faux decorative members 822 may include visual indicia 835, such as letters, logos, or other symbols. Thus, the wearer may, for example, without limitation add their initials to a main faux decorative member 837 and put their baby's name on other faux decorative members 839.

According to an illustrative embodiment, a method of manufacturing a necklace and teething device includes forming a plurality of modular units from a non-toxic substance suitable for an infant to place in his or her mouth, wherein each modular unit of the plurality of modular units is sized not to be a choking hazard and namely not to fit in a cylinder having an interior radius of 1.25 inches and a longitudinal length of 2.25 inches. The step of forming the modular units may be accomplished using injection molding, three-dimensional printing, or other techniques. The method further includes forming faux decorative members on each modular unit of the plurality of modular units, wherein the faux decorative members form a single modular unit but the faux decorative members appear to be individual decorative pieces of a size that would fit in a cylinder having an interior radius of 1.25 inches and a longitudinal length of 2.25 inches. The method further includes coupling the plurality of modular units to one another to form a ring to be placed around a wearer's neck and having an interior diameter between about 15 inches and 40 inches.

With reference to the method of the above paragraph and in particular to the step of coupling the plurality of modular units to one another to form a ring, the step may include using an attachment cord, wherein each of the plurality of modular units is formed with a bore through each modular unit, and wherein the attachment cord is disposed through the bores of each of the modular units to hold the plurality of modular units in the ring, or using a plurality of coupling devices for coupling adjacent ends of members of the plurality of modular units to form the ring. The method may also include attaching a releasable clasp to the ring of the types previously presented or others.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. A necklace and teething device comprising:
a plurality of modular units coupled to one another to form a ring to be placed around a wearer's neck, wherein the ring has an interior diameter in a range between about 15 inches and 40 inches;
wherein each modular unit of the plurality of modular units comprises a non-toxic substance that holds shape and is suitable for an infant to place in his or her mouth;
wherein each modular unit of the plurality of modular units is sized not to be a choking hazard if separated and namely sized so that each modular unit does not fit in a cylinder having an interior radius of 1.25 inches and a longitudinal length of 2.25 inches;
wherein each modular unit comprises a plurality of faux decorative members that form a single modular unit but at least some of the faux decorative members appear when viewed from a few feet away to be individual decorative pieces of a size that would fit in a cylinder having an interior radius of 1.25 inches and a longitudinal length of 2.25 inches; and
an attachment connector comprising one from a group consisting of:
an attachment cord, wherein each of the plurality of modular units is formed with a bore through the modular unit, and wherein the attachment cord is disposed through the bores of each of the modular units to hold the plurality of modular units in the ring, and
a plurality of coupling devices for coupling adjacent ends of modular units of the plurality of modular units to form the ring.

2. The necklace and teething device of claim 1, further comprising a selectively releasable clasp coupled to the ring.

3. The necklace and teething device of claim 2, wherein the selectively releasable clasp is selected from a group consisting of a barrel flat clasp, a spring ring clasp, a lobster claw clasp, a magnetic bali clasp, a toggle clasp, an oval toggle, alligator clip, and loop-and-hook closure.

4. The necklace and teething device of claim 1, wherein the plurality of coupling devices each comprise a male member and a female member, wherein introduction of the male member into the female member requires at least temporary compression of the male member or expansion of the female member.

5. The necklace and teething device of claim 1, wherein the non-toxic substance comprises silicone.

6. The necklace and teething device of claim 1, wherein the faux decorative members comprise members that look like individual decorative beads.

7. The necklace and teething device of claim 6, wherein the individual decorative beads are formed to look like one from the group consisting of a sphere, ellipsoid, cylinder, prism, parallelepiped, pyramid, and polyhedron.

8. The necklace and teething device of claim 1, wherein the plurality of modular units comprises:
a first modular unit comprising a singular member having a first plurality of faux decorative members comprising a first plurality of spheres;
a second modular unit comprising a singular member having a second plurality of faux decorative members comprising a first plurality of polyhedrons, a second plurality of spheres, and at least a first ellipsoid;
a third modular unit comprising a singular member having a third plurality of faux decorative members comprising at least a second and third ellipsoid, a third plurality of spheres, and a member having a two-dimensional silhouette that has three straight edges and one curved edge;
a fourth modular unit comprising a singular member having a fourth plurality of faux decorative members comprising a second plurality of polyhedrons, a fourth plurality of spheres, and at least a fourth ellipsoid; and
a fifth modular unit comprising a singular member having a fifth plurality of faux decorative members comprising a fifth plurality of spheres.

9. The necklace and teething device of claim 1,
further comprising a selectively releasable clasp coupled to the ring;
wherein the releasable clasp is selected from a group consisting of a barrel flat clasp, a spring ring clasp, a lobster claw clasp, a magnetic bali clasp, a toggle clasp, an oval toggle, alligator clip, and loop-and-hook closure;
wherein the faux decorative members comprise members that look like individual decorative beads having a longitudinal length less than two inches; and
wherein the individual decorative beads are formed to look like one from the group consisting of a sphere, ellipsoid, cylinder, prism, parallelepiped, pyramid, and polyhedron.

10. A method of manufacturing a necklace and teething device, the method comprising:
forming a plurality of modular units from a non-toxic substance that holds shape and is suitable for an infant to place in his or her mouth, wherein each modular unit of the plurality of modular units is sized not to be a choking hazard and namely not to fit in a cylinder having an interior radius of 1.25 inches and a longitudinal length of 2.25 inches;
forming faux decorative members on each modular unit of the plurality of modular units, wherein the faux decorative members form a single modular unit but the faux decorative members appear when viewed from a few feet away to be individual decorative pieces of a size that would fit in a cylinder having an interior radius of 1.25 inches and a longitudinal length of 2.25 inches; and
coupling the plurality of modular units to one another to form a ring to be placed around a wearer's neck and wherein the rings has an interior diameter between about 15 inches and 40 inches.

11. The method of claim 10, wherein the step of coupling the plurality of modular units to one another to form a ring comprises using a attachment connector comprising one of a group consisting of:
an attachment cord, wherein each of the plurality of modular units is formed with a bore through the modular unit, and wherein the attachment cord is disposed through the bores of each of the modular units to hold the plurality of modular units in the ring, and
a plurality of coupling devices for coupling adjacent ends of members of the plurality of modular units to form the ring.

12. The method of claim 11, further comprising coupling a selectively releasable clasp to the ring.

13. The method of claim 12, wherein the releasable clasp is selected from a group consisting of a barrel flat clasp, a spring ring clasp, a lobster claw clasp, a magnetic bali clasp, a toggle clasp, an oval toggle, alligator clip, and loop-and-hook closure.

14. The method of claim 11, wherein the plurality of coupling devices each comprise a male member and a female member, wherein introduction of the male member into the female member requires at least temporary compression of the male member or expansion of the female member.

15. The method of claim 10, wherein the non-toxic substance comprises silicone.

16. The method of claim 10, wherein the step of forming faux decorative members on each modular unit comprises comprise forming members that look like individual decorative beads but comprise a singular member.

17. The method of claim 16, wherein the individual beads are formed to look like one from a group consisting of a sphere, ellipsoid, cylinder, prism, parallelepiped, pyramid, and polyhedron.
